(19) United States
(12) Patent Application Publication
(10) Pub. No.: US 2024/0063437 A1
(43) Pub. Date: Feb. 22, 2024

(54) ORGANIC ELECTROLYTE AND SECONDARY BATTERY COMPRISING SAME

(71) Applicant: Samsung Electronics Co., Ltd., Suwon-si, Gyeonggi-do (KR)

(72) Inventors: Youngjoon Bae, Suwon-si, Gyeonggi-do (KR); Sangbok Ma, Suwon-si, Gyeonggi-do (KR); Taeyoung Kim, Suwon-si, Gyeonggi-do (KR); Sungjin Lim, Suwon-si, Gyeonggi-do (KR)

(21) Appl. No.: 18/260,628

(22) PCT Filed: Nov. 24, 2021
(86) PCT No.: PCT/KR2021/017382

§ 371 Date: Jul. 7, 2023

(30) Foreign Application Priority Data
Jan. 8, 2021 (KR) 10-2021-0002611

(51) Int. Cl. H01M 10/0569; H01M 10/0568

(52) U.S. Cl. CPC H01M 10/0569; H01M 10/0568; H01M 2300/0034; H01M 2300/004

(57) ABSTRACT

An organic electrolyte includes: a lithium salt, a non-aqueous solvent; and a nitrile-based compound represented by a certain formula, wherein the non-aqueous solvent includes a fluorinated cyclic carbonate compound and a fluorinated chain carbonate compound. A secondary battery including such an organic electrolyte is also disclosed.

### TECHNICAL FIELD

The present disclosure relates to an organic electrolyte having a novel composition and a secondary battery including the same.

### BACKGROUND ART

Electrolytes, for example, organic electrolytes, are used to move ions between a positive electrode and a negative electrode during a charging and discharging process of secondary batteries.

Organic electrolytes are decomposed at a high voltage of, for example, 5 V or more or 6 V or more, or cause a side reaction, which may damage the stability of batteries.

Accordingly, there is still a need for an organic electrolyte which is stable during charging at a high voltage, maintains a low overvoltage during discharging after high-voltage charging, and does not cause a side reaction at a discharge voltage of 3 V or less.

### DISCLOSURE

### Technical Problem

According to one aspect, provided are an organic electrolyte having a novel composition and a secondary battery including the same.

### Technical Solution

According to an aspect, there is provided an organic electrolyte including: a lithium salt; a non-aqueous solvent comprising a fluorinated cyclic carbonate compound and a fluorinated chain carbonate compound, and a nitrile-based compound represented by Formula 1 below:

N≡C-A₁-C≡N Formula 1
wherein, in Formula 1, A₁ is a C₄-C₁₀ alkylene group substituted or unsubstituted with at least one selected from —F, —Cl, —Br, —I, a cyano group, a C₁-C₁₀ alkyl group, a C₃-C₇ cycloalkyl group, and a C₁-C₁₀ alkoxy group.

According to another aspect, there is provided a secondary battery including: a positive electrode; a negative electrode; and the above-described organic electrolyte. Here, the secondary battery may be a lithium secondary battery or an all-solid battery.

### Advantageous Effects

A secondary battery including an organic electrolyte according to an aspect simultaneously has high voltage charge stability and low voltage discharge stability.

### DESCRIPTION OF DRAWINGS

FIG. 1 is a schematic view of a secondary battery according to one embodiment.

FIG. 2 is a charge/discharge curve graph of half-cells of Examples 1 to 5 and Comparative Example 2.

FIG. 3 is a charge/discharge curve graph of half-cells of Examples 4, 6, and 7 and Comparative Examples 1, 3, 7, and 8.

FIG. 4 shows graphs of first and second charge and discharge curves of half-cells of Example 4 and Comparative Examples 1 and 4 to 6.

### DESCRIPTIONS OF REFERENCE NUMERALS

| | |
|---|---|
| 1: lithium secondary battery | 2: negative electrode |
| 3: positive electrode | 4: separator |
| 5: battery case | 6: cap assembly |

### BEST MODE

### Mode for Invention

Various embodiments are illustrated in the accompanying drawings. The present inventive concept may, however, be embodied in different forms and should not be construed as limited to the embodiments set forth herein. Rather, these embodiments are provided so that the present disclosure will be thorough and complete, and will fully convey the scope of the present inventive concept to those skilled in the art. Like reference numerals designate like elements.

When it is described that an element is “on” another element, it will be understood that the element may be disposed directly on another element or still another element may be interposed therebetween. On the other hand, when it is described that an element is “directly on” another element, still another element is not interposed therebetween.

It will be understood that, although the terms “first,” “second,” and “third” may be used herein to describe various elements, components, regions, layers, and/or sections, these elements, components, regions, layers, and/or sections should not be limited by these terms. These terms are only used to distinguish one element, component, region, layer, or section from another region, layer, or section. Thus, a first element, component, region, layer, or section described below may be termed a second element, component, region, layer, or section without departing from the teachings of the present specification.

The term used herein is intended to describe only a specific embodiment and is not intended to limit the present inventive concept. As used herein, the singular forms “a,” “an,” and “the” are intended to include the plural forms, including “at least one,” unless the content clearly indicates otherwise. “At least one” should not be construed as being limited to the singular. As used herein, the term “and/or” includes any and all combinations of one or more of the associated listed items. The terms “includes,” “including,” “comprises,” and/or “comprising,” when used in the detailed description, specify a presence of stated features, regions, integers, steps, operations, elements, and/or components, but do not preclude the presence or addition of one or more other features, regions, integers, steps, operations, elements, components, and/or groups thereof.

Spatially relative terms such as “beneath,” “below,” “lower,” “above,” and “upper” may be used herein to easily describe one element or feature's relationship to another element or feature. It will be understood that the spatially relative terms are intended to encompass different orientations of a device in use or operation in addition to the orientation illustrated in the drawings. For example, when a device in the drawings is turned over, elements described as “below” or “beneath” other elements or features would then be “above” or “over” the other elements or features. Thus, the example term “below” may encompass both orientations of above and below. The device may be otherwise oriented (rotated 90 degrees or at other orientations), and the spatially relative terms used herein may be interpreted accordingly.

Unless otherwise defined, all terms (including technical and scientific terms) used herein have the same meaning as commonly understood by one of ordinary skill in the art to which the present disclosure belongs. In addition, it will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross-sectional views which are schematic diagrams of idealized embodiments. As such, variations from the shapes of the illustrations as a result, for example, of manufacturing techniques and/or tolerances, are to be expected. Thus, the embodiments described herein should not be construed as limited to the particular shapes regions of illustrated herein but may include deviations in shapes that result, for example, from manufacturing. For example, regions illustrated or described as being flat may be typically rough and/or have nonlinear features. Moreover, sharp-drawn angles may be round. Thus, regions illustrated in the drawings are schematic in nature and their shapes are not intended to illustrate the actual shape of a region and are not intended to limit the scope of the claims.

“Group” refers to a group of the periodic table of the elements according to the International Union of Pure and Applied Chemistry (“IUPAC”) Groups 1-18 group classification system.

While specific embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications, variations, improvements, and substantial equivalents.

Hereinafter, an organic electrolyte and a secondary battery including the same according to one or more embodiments will be described in more detail.

An organic electrolyte according to an aspect includes: a lithium salt; a non-aqueous solvent; and a nitrile-based compound represented by Formula 1 below, wherein the non-aqueous solvent includes a fluorinated cyclic carbonate compound and a fluorinated chain carbonate compound:

N≡C-A₁-C≡N Formula 1

In Formula 1, A₁ may be a C₄-C₁₀ alkylene group substituted or unsubstituted with at least one selected from —F, —Cl, —Br, —I, a cyano group, a C₁-C₁₀ alkyl group, a C₃-C₇ cycloalkyl group, and a C₁-C₁₀ alkoxy group.

In the related art, when fluorinated carbonate is used as an electrolyte, during discharging after high-voltage charging, an electrolyte has been decomposed due to a side reaction at a voltage of 3 V or less, resulting in a rapid decrease in capacity. In the related art, when dinitrile compound is used as an additive in an ethylene carbonate and dimethyl carbonate solvent, during high-voltage charging, due to the oxidation of a carbonate solvent, an insulating layer has been formed on a surface of a positive electrode, resulting in an increase in overvoltage during discharging.

Thus, in order to solve such limitations, the present inventors have conducted various experiments and studies and thus have found that, when an organic electrolyte according to an aspect of the present disclosure includes a fluorinated cyclic carbonate compound, a fluorinated chain carbonate compound, and a nitrile-based compound, a stable positive electrode film is formed at a high voltage, for example, a voltage of 5 V or more, and a side reaction is effectively suppressed at a low voltage by a fluorinated carbonate-based compound to suppress an increase in overvoltage, thereby completing the present disclosure. A secondary battery including an organic electrolyte according to one embodiment of the present disclosure may be stably driven in an electrochemical window in a wide range including a high voltage region of 5 V or more.

According to one embodiment, the C₄-C₁₀ alkylene group may be a linear or branched C₄-C₁₀ alkylene group. For example, the C₄-C₁₀ alkylene group may be a linear or branched C₆-C₈ alkylene group.

According to one embodiment, A₁ may be a linear C₄-C₁₀ alkylene group or a linear C₄-C₁₀ alkylene group substituted with at least one selected from —F, —Cl, —Br, —I, and a cyano group.

For example, A₁ may be a linear C₄-C₁₀ alkylene group.

According to one embodiment, the nitrile-based compound may be a dinitrile-based compound.

According to one embodiment, the nitrile-based compound may include at least one compound selected from 1,4-dicyanobutane, 1,5-dicyanopentane, 1,6-dicyanohexane, 1,7-dicyanoheptane, 1,8-dicyanooctane, 1,9-dicyanononane, and 1,10-dicyanodecane.

According to one embodiment, a content of the nitrile-based compound may be greater than 10 vol % and less than 80 vol % with respect to the total volume of the organic electrolyte.

For example, the content of the nitrile-based compound may be in a range of 15 vol % to 75 vol % or 30 vol % to 70 vol % with respect to the total volume of the organic electrolyte.

When the content of the nitrile-based compound satisfies the above range, an overvoltage may be maintained low when a battery is discharged after being charged with a high voltage.

According to one embodiment, the lithium salt may be selected from LiPF₆,LiBF₄, LiSbF₆, LiAsF₆,LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (wherein x and y are natural numbers), LiCl, LiI, and a mixture thereof.

For example, the lithium salt may include LiPF₆.

According to one embodiment, the lithium salt may be included in a concentration of 0.01 M to 1.0 M, but the present disclosure is not limited thereto. The lithium salt may be included in any range as long as the range does not affect cell driving.

According to one embodiment, the fluorinated cyclic carbonate compound may be represented by Formula 2 below:

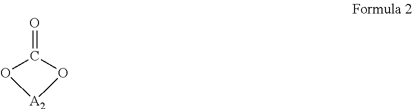

In Formula 2, A₂ is a C₁-C₄ alkylene group substituted with at least one selected from —F, —Cl, —Br, —I, a cyano group, a C₁-C₁₀ alkyl group, a C₃-C₇ cycloalkyl group, and a C₁-C₁₀ alkoxy group, wherein at least one selected from substituents of A₂ is —F.

According to one embodiment, A₂ may be a C₂-C₄ alkylene group in which at least one —F is substituted.

For example, A₂ may be *—CH₂—CHF—*′, *—CH₂—CF₂—*′, *—CHF—CHF—*′, *—CH₂—CH₂—CHF—*′, *—CH₂—CHF—CHF—*′, *—CH₂—CF₂—CHF—*′, *—CHF—CH₂—CHF—*′, *—CF₂—CH₂—CHF—*′, *—CHF—CHF—CHF—*′, *—CF₂—CHF—CHF—*′, *—CF₂—CF₂—CHF—*′, *—CH₂—CH₂—CF₂—*′, *—CH₂—CHF—CF₂—*′, *—CH₂—CF₂—CF₂—*′, *—CF₂—CH₂—CF₂—*′, *—CF₂—CHF—CF₂—*′, *—CF₂—CF₂—CF₂—*′, *—CH₂—CHF—CH₂—*′, *—CH₂—CF₂—CH₂—*′, *—CH₂—CH₂—CH₂—CHF—*′, *—CH₂—CH₂—CHF—CHF—*′, *—CH₂—CH₂—CF₂—CHF—*′, *—CH₂—CHF—CH₂—CHF—*′, *—CH₂—CF₂—CH₂—CHF—*′, *—CHF—CH₂—CH₂—CHF—*′, *—CF₂—CH₂—CH₂—CHF—*′, *—CH₂—CHF—CHF—CHF—*′, *—CH₂—CF₂—CHF—CHF—*′, *—CHF—CH₂—CHF—CHF—*′, *—CF₂—CH₂—CHF—CHF—*′, *—CH₂—CHF—CF₂—CHF—*′, *—CH₂—CF₂—CF₂—CHF—*′, *—CHF—CH₂—CF₂—CHF—*′, *—CF₂—CH₂—CF₂—CHF—*′, *—CH₂—CHF—CH₂—CHF—*′, *—CHF—CHF—CH₂—CHF—*′, *—CF₂—CHF—CH₂—CHF—*′, *—CHF—CF₂—CH₂—CHF—*′, *—CF₂—CF₂—CH₂—CHF—*′, *—CHF—CHF—CHF—CHF—*′, *—CHF—CHF—CF₂—CHF—*′, *—CHF—CF₂—CF₂—CHF—*′, *—CF₂—CF₂—CF₂—CHF—*′, *—CF₂—CHF—CHF—CHF—*′, *—CHF—CF₂—CHF—CHF—*′, *—CF₂—CHF—CF₂—CHF—*′, *—CF₂—CF₂—CHF—CHF—*′, *—CH₂—CH₂—CH₂—CF₂—*′, *—CH₂—CH₂—CHF—CF₂—*′, *—CH₂—CH₂—CF₂—CF₂—*′, *—CH₂—CHF—CH₂—CF₂—*′, *—CH₂—CF₂—CH₂—CF₂—*′, *—CHF—CH₂—CH₂—CF₂—*′, *—CF₂—CH₂—CH₂—CF₂—*′, *—CH₂—CHF—CHF—CF₂—*′, *—CH₂—CF₂—CHF—CF₂—*′, *—CF₂—CH₂—CHF—CF₂—*′, *—CH₂—CHF—CF₂—CF₂—*′, *—CH₂—CF₂—CF₂—CF₂—*′, *—CF₂—CHF—CH₂—CF₂—*′, *—CF₂—CF₂—CH₂—CF₂—*′, *—CF₂—CHF—CHF—CF₂—*′, *—CF₂—CHF—CF₂—CF₂—*′, or *—CF₂—CF₂—CF₂—CF₂—*′. Here, * and *′ are binding sites with oxygen atoms.

According to one embodiment, the fluorinated cyclic carbonate compound may include at least one selected from a fluoroethylene carbonate compound, a difluoroethylene carbonate compound, a fluoropropylene carbonate compound, a difluoropropylene carbonate compound, and a trifluoropropylene carbonate compound. For example, the fluorinated cyclic carbonate compound may include a fluoroethylene carbonate compound.

According to one embodiment, the fluorinated cyclic carbonate compound may be included in a content that is greater than 15 vol % and less than 55 vol % with respect to 100 vol % of the organic electrolyte.

Since the fluorinated cyclic carbonate compound is included in a content that is greater than 15 vol % and less than 55 vol %, the stability of a battery at a high voltage is improved.

According to one embodiment, the fluorinated chain carbonate compound may be represented by Formula 3 below:

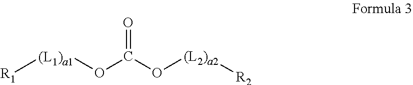

In Formula 3, L₁ and L₂ may each independently be a single bond or a C₁-C₁₀ alkylene group substituted or unsubstituted with at least one selected from —F, —Cl, —Br, —I, a cyano group, a C₁-C₁₀ alkyl group, a C₃-C₇ cycloalkyl group, and a C₁-C₁₀ alkoxy group,

a1 and a2 may independently be an integer selected from 1 to 3, R₁ and R₂ may each independently be a C₁-C₁₀ alkyl group substituted or unsubstituted with at least one selected from —F, —Cl, —Br, —I, a cyano group, a C₁-C₁₀ alkyl group, a C₃-C₇ cycloalkyl group, and a C₁-C₁₀ alkoxy group, and at least one selected from L₁, L₂, R₁, and R₂ may be substituted with —F.

According to one embodiment, R₁ and R₂ may each independently be a C₁-C₁₀ alkyl group in which at least one —F is substituted.

For example, R₁ and R₂ may each independently be selected from —CFHCH₃, —CF₂CH₃, —CH₂CFH₂, —CH₂CF₂H, —CH₂CF₃, —CFHCFH₂, —CFHCF₂H, —CFHCF₃, —CF₂CFH₂, —CF₂CF₂H, and —CF₂CF₃.

According to one embodiment, R₁ and R₂ may be identical to each other.

According to one embodiment, L₁ and L₂ may each independently be single bonds, and R₁ and R₂ may be selected form —CFHCH₃, —CF₂CH₃, —CH₂CFH₂, —CH₂CF₂H, —CH₂CF₃, —CFHCFH₂, —CFHCF₂H, —CFHCF₃, —CF₂CFH₂, —CF₂CF₂H, and —CF₂CF₃.

According to one embodiment, the fluorinated chain carbonate compound may be included in a content that is greater than 15 vol % and less than 55 vol % with respect to 100 vol % of the entire organic electrolyte.

When the content of the chain fluoride carbonate compound satisfies the above range, an increase in overvoltage may be suppressed when a battery is discharged after being charged with a high voltage.

According to one embodiment, the fluorinated cyclic carbonate compound and the fluorinated chain carbonate compound may be included in a content that is greater than 30 vol % and less than 70 vol % with respect to the total volume of the organic electrolyte.

For example, the fluorinated cyclic carbonate compound and the fluorinated chain carbonate compound may be included in a content of 40 vol % to 60 vol % with respect to the total volume of the organic electrolyte.

According to one embodiment, the fluorinated cyclic carbonate compound and the fluorinated chain carbonate compound may be mixed in a volume ratio of 3:7 to 7:3. For example, the fluorinated cyclic carbonate compound and the fluorinated chain carbonate compound may be mixed in a volume ratio of 4:6 to 6:4 or in a volume ratio of 5:5.

When the fluorinated cyclic carbonate compound and the fluorinated chain carbonate compound are included in the above volume ratio in the organic electrolyte, stability at a high voltage may be improved.

According to one embodiment, the nitrile-based compound included in the non-aqueous solvent may be included in a volume ratio that is greater than 30 vol % and less than 70 vol %.

For example, the volume ratio of the nitrile-based compound included in the non-aqueous solvent may be in a range of 40 vol % to 60 vol %.

According to one embodiment, the non-aqueous solvent may further include at least one solvent selected from an ether-based solvent, an ester-based solvent, and a ketone-based solvent as necessary.

For example, the ether-based solvent may include at least one selected from: 1,2-dimethoxyethane, 1,2-diethoxyethane, 1,2-dibuthoxyethane, dimethylether, diethylether, dibutylether, diethylene glycol dimethyl ether, diethylene glycol diethyl ether, triethylene glycol dimethyl ether, triethylene glycol diethyl ether, tetraethylene glycol dimethyl ether, tetraethylene glycol diethyl ether, dimethyl sulfoxide, and N,N-dimethyl acetamide; 1,3-dioxolane, 4,5-dimethyl-dioxolane, 4,5-diethyl-dioxolane -dioxolane, 4-methyl-1,3-dioxolane, 4-ethyl-1,3-dioxolane, tetrahydrofuran, 2-methyl tetrahydrofuran, 2,5-dimethyl tetrahydrofuran, 2,5-dimethoxy tetrahydrofuran, 2-ethoxy tetrahydrofuran, 2-methoxy-1,3-dioxolane, 2-vinyl-1,3-dioxolane, 2,2-dimethyl-1,3-dioxolane, 2-methoxy-1,3-dioxolane, 2-ethyl-2-methyl-1,3-dioxolane, tetrahydropyran, 1,4-dioxane, 1,2-dimethoxy benzene, 1,3-dimethoxy benzene, 1,4-dimethoxy benzene, and isosorbide dimethyl ether.

For example, the ester-based solvent may include at least one selected from methyl acetate, ethyl acetate, n-propyl acetate, dimethyl acetate, methyl propionate, ethyl propionate, γ-butyrolactone, decanolide, valerolactone, mevalonolactone, and caprolactone.

For example, the ketone-based solvent may include at least one selected from polymethylvinyl ketone and cyclohexanone.

A secondary battery according to an aspect may include: a positive electrode; a negative electrode; and the above-described organic electrolyte.

For example, the secondary battery may be a concept encompassing any battery which is reusable by being charged and may include, for example, a lithium secondary battery, a lithium ion polymer battery, and a lithium sulfur battery.

The lithium secondary battery may maintain an overvoltage increase rate of 0.3 V or less after being charged with a voltage of 6 V.

When the above-described organic electrolyte is used, an effect of stabilizing a surface of a positive electrode active material having high voltage characteristics is excellent, and thus an increase in resistance during discharging is suppressed, resulting in excellent battery driving characteristics.

The lithium secondary battery according to one embodiment may be manufactured through the following method.

First, a positive electrode is prepared.

For example, a positive electrode active material composition in which a positive electrode active material, a conductive agent, a binder, and a solvent are mixed is prepared. The positive electrode active material composition is applied directly on a positive electrode current collector to prepare a positive electrode plate. Alternatively, the positive electrode active material composition may be cast on a separate support, and then a film peeled off of the support may be laminated on a metal current collector to prepare the positive electrode.

The positive electrode active material may be used together with general lithium-containing metal oxide in addition to nickel-rich lithium-nickel composite oxide described above. The lithium-containing metal oxide may include, for example, at least one composite oxide of lithium and a metal selected from cobalt, manganese, nickel, and a combination thereof. A specific example of the positive electrode active material may include a compound represented by at least one selected from formulas of LiₐA_{1-b}B¹_{b}D¹₂ (wherein 0.90≤a≤1.8 and 0≤b≥0.5), LiₐE_{1-b}B¹_{b}O_{2-c}D¹_{c} (wherein 0.90≤a≤1.8, 0≤b≤0.5, and 0≤c≤0.05), LiE2−bB1bO4−cD1c (wherein 0≤b≤0.5 and 0≤c≤0.05), LiaNi1−b−cCobB1−cD1−α (wherein 0.90≤a≤1.8, 0≤b≤0.5, 0≤c≤0.05, and 0<α≤2), LiₐNi_{1-b-c}Co_{b}B¹_{c}D¹_{α} (wherein 0.90≤a≤1.8, 0≤b≤0.5, 0≤c≤0.05, and 0<α<2), LiₐNi_{1-b-c}Co_{b}B¹_{c}O_{2-α}F¹_{α} (wherein 0.90≤a≤1.8, 0≤b≤0.5, 0≤c≤0.05, and 0<α<2, LiₐNi_{1-b-c}Co_{b}B¹_{c}O_{2-α}F¹₂ (wherein 0.90≤a≤1.8, 0≤b≤0.5, 0≤c≤0.05, and 0<α<2), LiₐNi_{1-b-c}Mn_{b}B¹_{c}D¹_{α} (wherein 0.90≤a≤1.8, 0≤b≤0.5, 0≤c≤0.05, and 0<α≤2), LiₐNi_{1-b-c}Mn_{b}B¹_{c}O_{2-α}F¹_{α} (wherein 0.90≤a≤1.8, 0≤b≤0.5, 0≤c≤0.05, and 0<α<2), LiₐNi_{1 -b-c}Mn_{b}B¹_{c}O_{2-α}F¹₂ (wherein 0.90≤a≤1.8, 0≤b≤0.5, 0≤c≤0.05, and 0<α<2), LiₐNi_{b}E_{c}G_{d}O₂ (wherein 0.90≤a≤1.8, 0≤b≤0.9, 0≤c≤0.5, and 0.001≤d≤0.1); LiₐNi_{b}Co_{c}Mn_{d}GeO₂ (wherein 0.90≤a≤1.8, 0≤b≤0.9, 0≤c≤0.5, 0≤d≤0.5, and 0.001≤e≤0.1); LiₐNiG_{b}O₂ (wherein 0.90≤a≤1.8 and 0.001≤b≤0.1); LiₐCoG_{b}O₂ (wherein 0.90≤a≤1.8 and 0.001≤b≤0.1); LiₐMnG_{b}O₂ (wherein 0.90≤a≤1.8 and 0.001≤b≤0.1); LiₐMn₂G_{b}O₄ (wherein 0.90≤a≤1.8 and 0.001≤b≤0.1); QO₂; QS₂; LiQS₂; VO₅; LiV₂O₅; LiIO₂; LiNiVO₄; Li_{(3-f)}J₂(PO₄)₃ (wherein 0≤f≤2), Li_{(3-f)}Fe₂(PO₄)₃ (wherein 0≤f≤2); and LiFePO₄.

In the above formulas, A may be Ni, Co, Mn, or a combination thereof, B¹ may be Al, Ni, Co, Mn, Cr, Fe, Mg, Sr, V, a rare earth element, or a combination thereof, D¹ may be O, F, S, P, or a combination thereof, E may be Co, Mn, or a combination thereof, F¹ may be F, S, P, or a combination thereof, G is Al, Cr, Mn, Fe, Mg, La, Ce, Sr, V, or a combination thereof, Q may be Ti, Mo, Mn, or a combination thereof, I may be Cr, V, Fe, Sc, Y, or a combination thereof, and J may be V, Cr, Mn, Co, Ni, Cu, or a combination thereof.

For example, LiCoO₂, LiMnₓO₂ₓ (wherein x=1 or 2), LiNi₁₋ₓMnₓO₂, (wherein 0<x<1), LiNi_{1-x-y}CoₓMn_{y}O₂ (wherein 0≤x≤0.5, 0≤y≤0.5, and 1−x−y>0.5), LiFePO₄, or the like may be used.

Of course, a compound having a coating layer on a surface of the compound may be used, or a mixture of the compound and a compound having a coating layer may be used. The coating layer may include a coating element compound of an oxide or hydroxide of the coating element, an oxyhydroxide of the coating element, an oxycarbonate of the coating element, or a hydroxycarbonate of the coating element. A compound constituting the coating layer may be amorphous or crystalline. The coating element included in the coating layer may include Mg, Al, Co, K, Na, Ca, Si, Ti, V, Sn, Ge, Ga, B, As, Zr, or a mixture thereof. In a process of forming the coating layer, any coating method may be used as long as the compound may be coated with such elements through a method (for example, a spray coating method or a dipping method) that does not adversely affect physical properties of the positive electrode active material. Since the coating method is known well to those who work in the related field, a detailed description thereof will be omitted.

As the conductive agent, a material is not particularly limited as long as the material has conductivity without causing a chemical change in a battery. For example, the conductive agent may include graphite such as natural graphite or artificial graphite, carbon black such as carbon black, acetylene black, Ketjen black, channel black, furnace black, lamp black, or summer black, a conductive fiber such as a carbon fiber or a metal fiber, fluorinated carbon, a metal powder such as an aluminum or nickel powder, conductive whiskey such as zinc oxide or potassium titanate, conductive metal oxide such as titanium oxide, a conductive agents such as a polyphenylene derivative, or the like.

A content of the conductive agent may be in a range of 1 wt % to 20 wt % with respect to the total weight of the positive electrode active material composition.

The binder is a component that assists with binding between an active material and a conductive agent and with binding with a current collector. The binder may be typically added in a content of 1 wt % to 30 wt % with respect to the total weight of the positive electrode active material composition. Examples of the binder may include polyvinylidene fluoride (PVDF), polyvinylidene chloride, polybenzimidazole, polyimide, polyvinyl acetate, polyacrylonitrile, polyvinyl alcohol, carboxymethyl cellulose (CMC), starch, hydroxypropyl cellulose, regenerated cellulose, polyvinylpyrrolidone, tetrafluoroethylene, polyethylene, polypropylene, polystyrene, polymethylmethacrylate, polyaniline, acrylonitrile butadiene styrene, a phenol resin, an epoxy resin, polyethylene terephthalate, polytetrafluoroethylene, polyphenylene sulfide, polyamideimide, polyetherimide, polyethersulfone, polyamide, polyacetal, polyphenylene oxide, polybutylene terephthalate, an ethylene-propylene-diene ter-polymer (EPDM), sulfonated EPDM, styrene butadiene rubber (SBR), fluoro rubber, various copolymers, and the like.

N-methylpyrrolidone, acetone, or water may be used as the solvent, but the present disclosure is not limited thereto. Any solvent usable in the art may be used. A content of the solvent may be in a range of, for example, 10 parts by weight to 100 parts by weight with respect to 100 parts by weight of the positive electrode active material. When the content of the solvent is within the above range, it is easy to form an active material layer.

The contents of the positive electrode active material, the conductive agent, the binder, and the solvent are at levels that are commonly used in a lithium secondary battery. One or more of the conductive agent, the binder, and the solvent may be omitted according to the use and configuration of a lithium secondary battery.

Contents of the positive electrode active material, a conductive agent, a filler, the binder, and the solvent are at levels that are commonly used in a lithium battery. One or more of the conductive agent, the filler, the binder, and the solvent may be omitted according to the use and configuration of a lithium battery.

For example, N-methylpyrrolidone (NMP) may be used as the solvent, PVDF or a PVDF copolymer may be used as the binder, and carbon black or acetylene black may be used as a conductive agent. For example, after 94 wt % of the positive electrode active material, 3 wt % of the binder, and 3 wt % of the conductive agent are mixed in a powder state, NMP may be added to prepare slurry such that a solid content is 70 wt %, and then the slurry is applied, dried, and rolled, thereby preparing the positive electrode.

The positive electrode current collector may be generally prepared to have a thickness of 3 μm to 50 μm. As the positive electrode current collector, a material may not be particularly limited as long as the material has high conductivity without causing a chemical change in a corresponding battery. For example, the positive electrode current collector may include stainless steel, aluminum, nickel, titanium, or fired carbon or may include aluminum or stainless steel which is surface-treated with carbon, nickel, titanium, silver, or the like. A fine unevenness may be formed on a surface of a current collector to increase adhesiveness of a positive electrode active material, and the current collector may have various forms such as a film, a sheet, a foil, a net, a porous body, a foam body, and a nonwoven fabric.

A loading level of the prepared positive electrode active material composition may be 30 mg/cm² or more, for example 35 mg/cm² or more, and specifically 40 mg/cm² or more. An electrode density may be 3 g/cc or more, for example 3.5 g/cc or more. As a design that emphasizes an energy density, a design, in which a loading level is in a range of 35 mg/cm² or more and 50 mg/cm² or less, and a density is 3.5 g/cc or more and 4.2 g/cc or less, may be preferred. For example, the positive electrode may be an electrode plate of which both surfaces are coated and which has a loading level of 37 mg/cc and a density of 3.6 g/cc.

Next, a negative electrode is prepared.

For example, a negative active material composition may be prepared by mixing a negative active material, a conductive agent, a binder, and a solvent. The negative electrode active material composition may be applied directly on a negative electrode current collector to prepare a negative electrode plate. Alternatively, the negative electrode active material composition may be cast on a separate support, and then a film peeled off of the support may be laminated on a metal current collector to prepare the negative electrode plate.

The negative electrode active material may be, for example, a silicon-based compound, silicon oxide (SiOₓ) (wherein 0<x<2)), or a composite of a silicon-based compound and a carbon-based material. Here, a size (for example, an average particle diameter) of silicon particles may be less than 200 nm, for example, in a range of 10 nm to 150 nm. The term “size” may refer to an average particle diameter when silicon particles are spherical and may refer to an average long axis length when the silicon particles are non-spherical.

When the size of the silicon particles is within the above range, life characteristics are excellent, and thus a lifetime of a lithium secondary battery may be further improved when an electrolyte according to one embodiment is used.

The carbon-based material may be crystalline carbon, amorphous carbon, or a mixture thereof. The crystalline carbon may be graphite such as natural graphite or artificial graphite having an amorphous, plate-like, flake-like, spherical, or fibrous form. The amorphous carbon may be soft carbon (low-temperature fired carbon), hard carbon, mesophase pitch carbide, or fired coke.

The composite of a silicon-based compound and a carbon-based material may be, for example, a composite having a structure in which silicon particles are arranged on graphite, or a composite having a structure in which silicon particles are included on a surface of graphite and inside graphite. The composite may be, for example, an active material in which silicon (Si) particles having an average particle diameter of 200 nm or less, for example, in a range of 100 nm to 200 nm, and specifically, 150 nm are dispersed on graphite particles and then coated with carbon, or an active material in which silicon (Si) particles are present on graphite and inside graphite. Such a composite is commercially available as the trade name SCN1 (Si particle on graphite) or SCN2 (Si particle inside as well as on graphite). CN1 is an active material obtained by dispersing silicon (Si) particles having an average particle diameter of about 150 nm on graphite particles and then coating the dispersed silicon (Si) particles with carbon. SCN2 is an active material in which silicon (Si) particles having an average particle diameter of about 150 nm are present on graphite and inside graphite.

As the negative electrode active material, a material may be used together with the above-described negative electrode active material as long as the material is usable as a negative electrode active material of a lithium secondary battery in the art. For example, the negative electrode active material may be Si, Sn, Al, Ge, Pb, Bi, Sb, a Si-Y alloy (wherein Y is an alkali metal, an alkaline earth metal, a Group 13 to Group 16 element, a transition metal, a rare earth element, or a combination thereof and is not Si) or a Sn—Y alloy (wherein Y is an alkali metal, an alkaline earth metal, a Group 13 to Group 16 element, a transition metal, a rare earth element, or a combination thereof and is not Sn). The element Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Jr, Pd, Pt, Cu, Ag, Au, Zn, Cd, B, Al, Ga, Sn, In, Ge, P, As, Sb, Bi, S, Se, Te, Po, or a combination thereof.

For example, transition metal oxide may be lithium titanium oxide, vanadium oxide, or lithium vanadium oxide.

The conductive agent and the binder in the negative electrode active material composition may be the same as those in the above-described positive electrode active material composition.

However, in the negative electrode active material composition, water may be used as the solvent. For example, water may be used as the solvent, carboxymethyl cellulose (CMC), SBR, an acrylate-based polymer, or a methacrylate-based polymer may be used as the binder, and carbon black, acetylene black, or graphite may be used as the conductive agent.

Contents of the negative electrode active material, the conductive agent, the binder, and the solvent are at levels that are commonly used in a lithium secondary battery. One or more of the conductive agent, the binder, and the solvent may be omitted according to the use and configuration of a lithium secondary battery.

For example, after 94 wt % of the negative electrode active material, 3 wt % of the binder, and 3 wt % of a conductive agent are mixed in a powder state, water is added to prepare slurry such that a solid content is 70 wt %, and then the slurry is applied, dried, and rolled, thereby preparing the negative electrode plate.

The negative electrode current collector is generally prepared to have a thickness of 3 μm to 50 μm. As the negative electrode current collector, a material is not particularly limited as long as the material has high conductivity without causing a chemical change in a corresponding battery. For example, the negative electrode current collector may include copper, stainless steel, aluminum, nickel, titanium, or fired carbon or may include copper or stainless steel which is surface-treated with carbon, nickel, titanium, silver, or the like. In addition, similarly to the positive electrode current collector, an unevenness may be formed on a surface of the negative electrode current collector to strengthen bonding strength of a negative electrode active material, and the negative electrode current collector may have various forms such as a film, a sheet, a foil, a net, a porous body, a foam body, and a nonwoven fabric.

A loading level of the negative active material composition is set according to the loading level of the positive active material composition. For example, the loading level of the negative electrode active material composition may be 12 mg/cm² or more, for example, 15 mg/cm² or more, according to capacity of the negative electrode active material composition per gram. An electrode density may be 1.5 g/cc or more, for example, 1.6 g/cc or more. As a design that emphasizes an energy density, a design, in which a density is in a range of 1.65 g/cc and or more and 1.9 g/cc or less, is preferred.

Next, a separator to be inserted between the positive electrode and the negative electrode is prepared.

As the separator, any separator commonly used in a lithium battery may be used. A separator having low resistance to the movement of ions in an electrolyte and an excellent electrolyte impregnation ability may be used. For example, the separator may include at least one selected from a glass fiber, polyester, Teflon, polyethylene, polypropylene, polytetrafluoroethylene (PTFE), and a combination thereof and may be in the form of a nonwoven fabric or a woven fabric. For example, a windable separator including polyethylene, polypropylene, or the like may be used in a lithium ion battery, and a separator having an excellent electrolyte impregnation ability may be used in a lithium ion polymer battery. For example, the separator may be prepared according to the following method.

A polymer resin, a filler, and a solvent are mixed to prepare a separator composition. The separator composition may be applied directly on an electrode and dried to form the separator. Alternatively, the separator composition may be cast on a support, and then a separator film peeled off of the support may be laminated on an electrode to form the separator.

The polymer resin used for preparing the separator is not particularly limited, and any material used in a binding material of an electrode plate may be used. For example, the polymer resin may include a vinylidene fluoride/hexafluoropropylene copolymer, PVDF, polyacrylonitrile, polymethyl methacrylate, or a mixture thereof.

Next, the above-described organic electrolyte is prepared.

According to one embodiment, in addition to the above-described electrolyte, the organic electrolyte may further include a non-aqueous electrolyte, a solid electrolyte, and an inorganic solid electrolyte.

The organic solid electrolyte may include, for example, a polyethylene derivative, a polyethylene oxide derivative, a polypropylene oxide derivative, a phosphate ester polymer, polyester sulfide, polyvinyl alcohol, polyvinylidene fluoride, or a polymer including an ionic dissociation group.

The inorganic solid electrolyte may include, for example, at least one selected from nitrides, halides, and sulfates of Li such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, and Li₃PO₄—Li₂S—SiS₂.

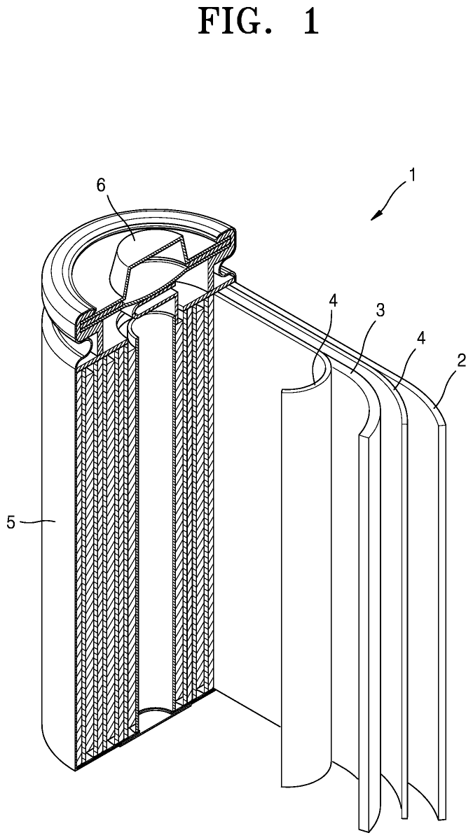

As shown in FIG. 1, a lithium secondary battery 1 includes a positive electrode 3, a negative electrode 2, and a separator 4. The positive electrode 3, the negative electrode 2, and the separator 4 are wound or folded to be accommodated in a battery case 5. Subsequently, an electrolyte is injected into the battery case 5, and the battery case 5 is sealed with a cap assembly 6 to complete the lithium secondary battery 1. The battery case may have a cylindrical shape, a prismatic shape, a thin film shape, or the like. For example, the lithium secondary battery may be a large-sized thin film battery. The lithium secondary battery may be a lithium ion battery.

The separator may be disposed between the positive electrode and the negative electrode to form a battery structure. The battery structure is stacked in a bi-cell structure and then is impregnated in an electrolyte, an obtained result material is accommodated in a pouch, and the pouch is sealed to complete a lithium ion polymer battery.

In addition, a plurality of battery structures may be stacked to form a battery pack, and such a battery pack may be used in all devices requiring high capacity and high power. For example, the plurality of battery structures may be used in a laptop computer, a smartphone, an electric vehicle, and the like.

Since the lithium secondary battery according to one embodiment has excellent resistance stability when discharged after being charged with a high voltage, for example, 5 V or more, a discharge overvoltage may be maintained low to exhibit excellent battery characteristics.

Since an operating voltage of the lithium secondary battery to which the positive electrode, the negative electrode, and the electrolyte are applied has, for example, a lower limit of 1.3 V to 1.7 V and an upper limit of 4.5 V to 6.0 V, the lithium secondary battery may be stably driven in an electrochemical window in a wide range including a high voltage range.

In addition, the lithium secondary battery may be used in, for example, a power tool that moves by receiving power from an electric motor, an electric motor vehicle such as an electric vehicle (EV), a hybrid electric vehicle (HEV), or a plug-in hybrid electric vehicle (PHEV), an electric two-wheeled vehicle such as an electric bike (E-bike) or an electric scooter (E-scooter), an electric golf cart, a power storage system, and the like, but the present disclosure is not limited thereto.

As used herein, the term “alkyl” refers to fully saturated branched or unbranched (or straight-chained or linear) hydrocarbon.

Non-limiting examples of “alkyl” include methyl, ethyl, n-propyl, isopropyl, n-butyl, isobutyl, sec-butyl, n-pentyl, isopentyl, neopentyl, iso-amyl, n-hexyl, 3-methylhexyl, 2,2-dimethylpentyl, 2,3-dimethylpentyl, n-heptyl, and the like.

The term “alkylene” refers to divalent linear or branched hydrocarbon, “C₁-C₁₀ alkylene group” refers to a divalent hydrocarbon group including 1 to 10 carbon atoms, for example, a linear alkylene group of —(CH₂)ₙ— (wherein n is an integer of 1 to 10) or a branched alkylene group of —CH₂CH(CH₃)(CH₂)ₘ— (wherein m is an integer of 1 to 7).

The term “cycloalkyl group” refers to monovalent cyclic hydrocarbon, and “C₃-C₇ cycloalkyl group” refers to a cyclic group including 3 to 7 ring carbon atoms, for example, a cyclopropyl group or a cyclobutanyl group.

The term “alkoxy group” refers to a group represented by —OR₁₀ (wherein R₁₀ is an alkyl group), and “C₁-C₁₀ alkoxy group” is —OR₁₁ (wherein R₁₁ is a C₁-C₁₀ alkyl group) and refers to, for example, a methoxy group or an ethoxy group.

Hereinafter, the present disclosure will be described in more detail through the following Examples and Comparative Examples. However, the following Examples and Comparative Examples are merely presented to exemplify the present disclosure, and the scope of the present disclosure is not limited thereto.

### EXAMPLES

### Preparation of Organic Electrolyte

### Preparation Example 1

An organic electrolyte was prepared using 0.5 M LiPF₆ as a lithium salt in a non-aqueous organic solvent in which fluoroethylene carbonate, bis(2,2,2-trifluoroethyl)carbonate, and 1,4-dicyanobutane were mixed in a volume ratio of 25:25:50.

### Preparation Example 2

An organic electrolyte was prepared in the same manner as in Preparation Example 1, except that 1,5-dicyanopentane was used instead of 1,4-dicyanobutane.

### Preparation Example 3

An organic electrolyte was prepared in the same manner as in Preparation Example 1, except that 1,6-dicyanohexane was used instead of 1,4-dicyanobutane.

### Preparation Example 4

An organic electrolyte was prepared in the same manner as in Preparation Example 1, except that 1,8-dicyanooctane was used instead of 1,4-dicyanobutane.

### Preparation Example 5

An organic electrolyte was prepared in the same manner as in Preparation Example 1, except that 1,10-dicyanodecane was used instead of 1,4-dicyanobutane.

### Preparation Example 6

An organic electrolyte was prepared in the same manner as in Preparation Example 1, except that 1,8-dicyanooctane was used instead of 1,4-dicyanobutane and fluoroethylene carbonate, bis(2,2,2-trifluoroethyl)carbonate, and 1,8-dicyanooctane were mixed in a volume ratio of 35:35:30.

### Preparation Example 7

An organic electrolyte was prepared in the same manner as in Preparation Example 1, except that 1,8-dicyanooctane was used instead of 1,4-dicyanobutane and fluoroethylene carbonate, bis(2,2,2-trifluoroethyl)carbonate, and 1,8-dicyanooctane were mixed in a volume ratio of 15:15:70.

### Preparation Example 8

An organic electrolyte was prepared in the same manner as in Preparation Example 1, except that 1,4-dicyanobutane was not used and fluoroethylene carbonate and bis(2,2,2-trifluoroethyl)carbonate was mixed in a volume ratio of 1:1.

### Preparation Example 9

An organic electrolyte was prepared in the same manner as in Preparation Example 1, except that 1,3-dicyanopropane was used instead of 1,4-dicyanobutane.

### Preparation Example 10

An organic electrolyte was prepared in the same manner as in Preparation Example 1, except that 1,8-dicyanooctane was used instead of 1,4-dicyanobutane and fluoroethylene carbonate, bis(2,2,2-trifluoroethyl)carbonate, and 1,8-dicyanooctane were mixed in a volume ratio of 48.5:48.5:3.

### Preparation Example 11

An organic electrolyte was prepared using 0.5 M LiPF₆as a lithium salt in a non-aqueous organic solvent in which ethylene carbonate, dimethyl carbonate, and 1,8-dicyanoctane were mixed in a volume ratio of 1:1:2.

### Preparation Example 12

An organic electrolyte was prepared in the same manner as in Preparation Example 1, except that a non-aqueous solvent in which fluoroethylene carbonate and 1,8-dicyanobutane were mixed in a volume ratio of 1:1 was used as a non-aqueous solvent.

### Preparation Example 13

An organic electrolyte was prepared in the same manner as in Preparation Example 1, except that a non-aqueous organic solvent in which bis(2,2,2-trifluoroethyl)carbonate and 1,8-dicyanobutane were mixed in a volume ratio of 50:50 was used as a non-aqueous solvent.

### Preparation Example 14

An organic electrolyte was prepared in the same manner as in Preparation Example 1, except that fluoroethylene carbonate, bis(2,2,2-trifluoroethyl)carbonate, and 1,4-dicyanobutane were mixed in a volume ratio of 45:45:10.

### Preparation Example 15

An organic electrolyte was prepared in the same manner as in Preparation Example 1, except that fluoroethylene carbonate, bis(2,2,2-trifluoroethyl)carbonate, and 1,4-dicyanobutane were mixed in a volume ratio of 10:10:80.

### Manufacturing of Half-Cell

### Example 1

Slurry was prepared by mixing a positive electrode active material, a conductive agent, and a binder in a weight ratio of 75:15:10. Here, LiFePO₄ was used as the positive electrode active material, Super P was used as the conductive agent, and PVDF was used as the binder.

The slurry was uniformly applied on an Al current collector and vacuum-dried at a temperature of 120° C. for 2 hours to prepare a positive electrode. A loading level of an electrode plate was 0.75 mg/cm², and an electrode density thereof was 0.36 g/cc.

A half-cell was manufactured according to a commonly known process using the prepared positive electrode as a working electrode, using a lithium foil as a counter electrode, and using the organic electrolyte prepared in Preparation Example 1.

### Examples 2 to 7

Half-cells were manufactured in the same manner as in Example 1, except that the organic electrolytes prepared in Preparation Examples 2 to 7 were used instead of the organic electrolyte prepared in Preparation Example 1.

### Comparative Examples 1 to 8

Half-cells were manufactured in the same manner as in Example 1, except that the organic electrolytes prepared in Preparation Examples 8 to 15 were used instead of the organic electrolyte prepared in Preparation Example 1.

### Evaluation Example 1: Electrochemical Evaluation According to Type of Nitrile-Based Compound

To obtain and evaluate the initial charging and discharging curve, the half-cells assembled and manufactured in Examples 1 to 5 and Comparative Examples 1 and 2 were charged in a constant current (CC) mode up to 6 V at 0.1 C, and then were discharged in a CC mode down to 2 V at 0.025 C.

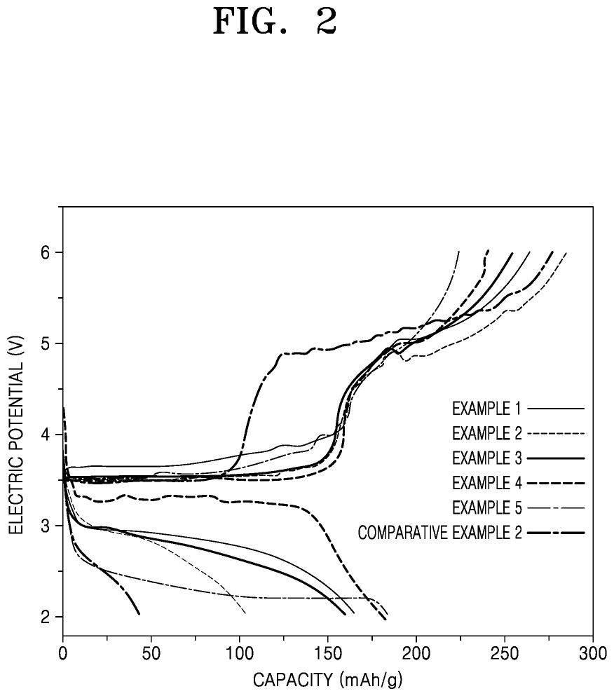

A curve of capacity and a voltage according to charging and discharging was obtained for each cell. The obtained curve is shown in FIG. 2.

Referring to FIG. 2, in a nitrile-based compound, except for two cyano groups, when the number of carbon atoms is in a range of 4 or more and 10 or less, it is confirmed that charging is possible at a voltage of 5 V or more, a rapid voltage drop may be suppressed during discharging, and a discharge capacity of 100 mAh/g or higher is obtainable.

### Evaluation Example 2: Electrochemical Evaluation According to Content Ratio of Nitrile-Based Compound

The half-cells manufactured in Examples 4, 6, and 7 and Comparative Examples 1, 3, 7, and 8 were charged in a CC mode up 6 V at 0.1 C, and then were discharged in a CC mode down to 2 V at 0.025 C.

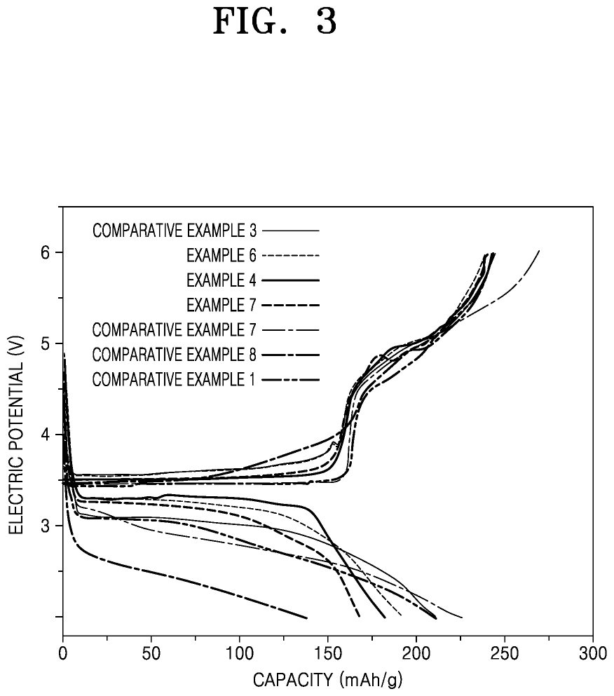

A curve of capacity and a voltage according to charging and discharging was obtained for each cell. The obtained curve is shown in FIG. 3.

Referring to FIG. 3, overdischarge during discharging was reduced as an amount of a nitrile-based compound was increased, the smallest overdischarge amount was confirmed in Example 4, and overcharging was confirmed in Comparative Examples 3 and 7 including a smaller amount of the nitrile-based compound than Example 4. In addition, even in the case of Comparative Example 8 using a larger amount of the nitrile-based compound than the nitrile-based compound included in the organic electrolyte used in Example 7, it was confirmed that an overdischarge amount was considerably increased.

### Evaluation Example 3: Electrochemical Evaluation According to Combination of Fluorinated Carbonate and Nitrile-Based Compound

The half-cells manufactured in Example 4 and Comparative Example 1 and 4 to 6 were charged in a CC mode up to 6 V at 0.1 C, and then were discharged in a CC mode down to 2 V at 0.025 C. Subsequently, a charging and discharging cycle was additionally performed once in the same manner.

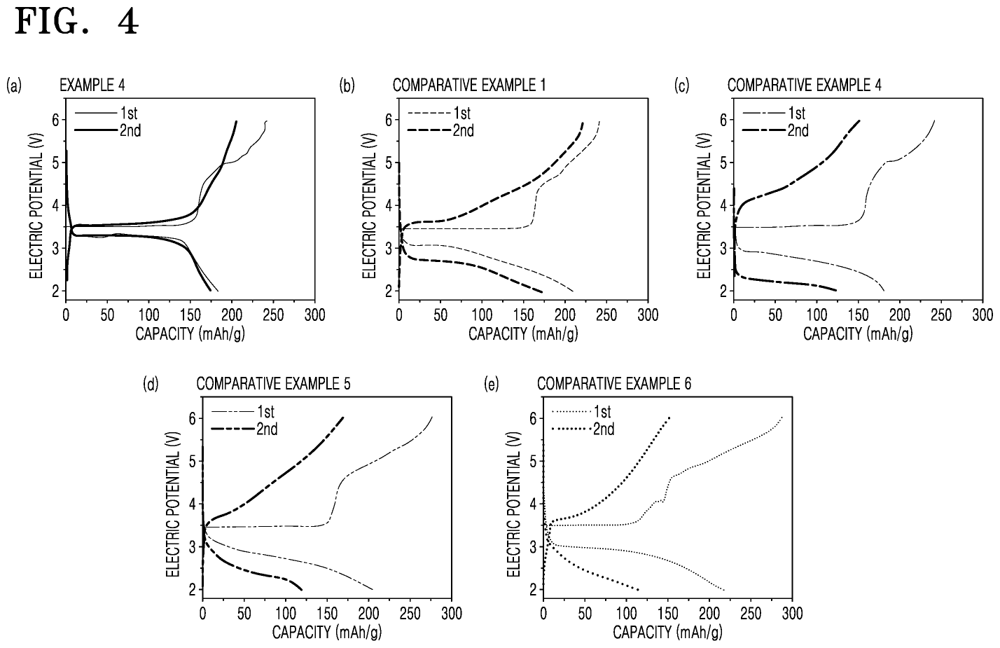

A curve of capacity and a voltage according to charging and discharging was obtained for each cell. The obtained curve is shown in FIG. 4.

Referring to FIG. 4, in Comparative Examples 1 and 4 using an organic electrolyte not including any one of fluorinated carbonate (that is, fluorinated cyclic carbonate and fluorinated chain carbonate) and a nitrile-based compound, it was confirmed that, in a secondary charge/discharge curve, an overvoltage was rapidly increased, and capacity was decreased. On the other hand, in Example 4 using an organic electrolyte including both carbonate fluoride and a nitrile-based compound, it was confirmed that, during primary charging/discharging and secondary charging/discharging, an overvoltage was not increased, and capacity was maintained constant.

In addition, when any one of fluorinated cyclic carbonate and fluorinated chain carbonate was not included in an organic electrolyte including a nitrile-based compound, it was confirmed that, in a second charging/discharging cycle, an overvoltage increased rapidly and capacity decreased .

Through such results, it was confirmed that an organic electrolyte including fluorinated cyclic carbonate, fluorinated chain carbonate, and a nitrile-based compound at the same time had a stable capacity retention rate effect.

While one or more embodiments have been described with reference to the drawings and Examples, the description merely illustrates, and it will be understood by those of ordinary skill in the art that various modifications and other equivalent embodiments are possible therefrom. Therefore, the protection scope of the present disclosure should be defined by the appended claims.

1. An organic electrolyte comprising:
a lithium salt;
a non-aqueous solvent comprising a fluorinated cyclic carbonate compound and a fluorinated chain carbonate compound; and
a nitrile-based compound represented by Formula 1 below:
N≡C-A₁-C≡N Formula 1
wherein, in Formula 1, A₁ is a C₄-C₁₀ alkylene group substituted or unsubstituted with at least one of —F, —Cl, —Br, —I, a cyano group, a C₁-C₁₀ alkyl group, a C₃-C₇ cycloalkyl group, or a C_{1-C10} alkoxy group.

2. The organic electrolyte of claim 1, wherein the C₄-C₁₀ alkylene group is a linear or branched C₄-C₁₀ alkylene group.

3. The organic electrolyte of claim 2, wherein the C₄-C₁₀ alkylene group is a linear or branched C₆-C₈ alkylene group.

4. The organic electrolyte of claim 1, wherein the nitrile-based compound comprises at least one of 1,4-dicyanobutane, 1,5-dicyanopentane, 1,6-dicyanohexane, 1,7-dicyanoheptane, 1,8-dicyanooctane, 1,9-dicyanononane, or 1,10-dicyanodecane.

5. The organic electrolyte of claim 1, wherein a content of the nitrile-based compound is greater than 10 vol % and less than 80 vol % with respect to a total volume of the organic electrolyte.

6. The organic electrolyte of claim 1, wherein the lithium salt is LiPF₆, LiBF₄, LiSbF₆, LiAsF₆, LiClO₄, LiCF₃SO₃, Li(CF₃SO₂)₂N, LiC₄F₉SO₃, LiAlO₂, LiAlC₄, LiN(CₓF₂ₓ₊₁SO₂)(C_{y}F_{2y+1}SO₂), (wherein x and y are natural numbers), LiCl, LiI, or a mixture thereof.

7. The organic electrolyte of claim 1, wherein the lithium salt is contained in a concentration of 0.01 M to 1.0 M.

8. The organic electrolyte of claim 1, wherein the fluorinated cyclic carbonate compound is represented by Formula 2 below: 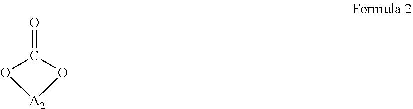
wherein, in Formula 2, A₂ is a C₁-C₄ alkylene group substituted with at least one of —F, —Cl, —Br, —I, a cyano group, a C₁-C₁₀ alkyl group, a C₃-C₇ cycloalkyl group, and a C₁-C₁₀ alkoxy group, and at least one substituents of A₂ is —F.

9. The organic electrolyte of claim 8, wherein A₂ is a C₂-C₄ alkylene group substituted with at least one —F.

10. The organic electrolyte of claim 1, wherein the fluorinated cyclic carbonate compound comprises at least one of a fluoroethylene carbonate compound, a difluoroethylene carbonate compound, a fluoropropylene carbonate compound, a difluoropropylene carbonate compound, or a trifluoropropylene carbonate compound.

11. The organic electrolyte of claim 1, wherein the fluorinated cyclic carbonate compound is contained in a content that is greater than 15 vol % and less than 55 vol % with respect to 100 vol % of the organic electrolyte.

12. The organic electrolyte of claim 1, wherein the fluorinated chain carbonate compound is represented by Formula 3 below: 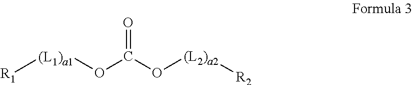
wherein, in Formula 3, L₁ and L₂ are each independently a single bond or a C₁-C₁₀ alkylene group substituted or unsubstituted with at least one of −F, —Cl, —Br, —I, a cyano group, a C₁-C₁₀ alkyl group, a C₃-C₇ cycloalkyl group, or a C₁-C₁₀ alkoxy group, a1 and a2 are independently an integer selected from 1 to 3, R₁ and R₂ are each independently a C₁-C₁₀ alkyl group unsubstituted or substituted with at least one of —F, —Cl, —Br, —I, a cyano group, a C₁-C₁₀ alkyl group, a C₃-C₇ cycloalkyl group, or a C₁-C₁₀ alkoxy group, and at least one of L₁, L_{2,} R₁, or R₂ is substituted with —F.

13. The organic electrolyte of claim 12, R₁ and R₂ are each independently a C₁-C₁₀ alkyl group in which at least one —F is substituted.

14. The organic electrolyte of claim 12, wherein R₁ and R₂ are each independently CFHCH₃, —CF₂CH₃, —CH₂CFH₂, —CH₂CF₂H, —CH₂CF₃, —CFHCFH₂, —CFHCF₂H, —HCF₃, —CF₂CFH₂, —CF₂CF₂H, or —CF₂CF₃.

15. The organic electrolyte of claim 12, wherein R₁ and R₂ are identical to each other.

16. The organic electrolyte of claim 1, wherein the fluorinated chain carbonate compound is contained in a content that is greater than 15 vol % and less than 55 vol % with respect to 100 vol % of the organic electrolyte.

17. The organic electrolyte of claim 1, wherein the fluorinated cyclic carbonate compound and the fluorinated chain carbonate compound are contained in a content that is greater than 30 vol % and less than 70 vol % with respect to a total volume of the organic electrolyte.

18. The organic electrolyte of claim 1, wherein the non-aqueous solvent further comprises at least one solvent selected from an ether-based solvent, an ester-based solvent, and a ketone-based solvent.

19. A secondary battery comprising:
a positive electrode;
a negative electrode; and
the organic electrolyte of claim 1.

20. The secondary battery of claim 19, wherein the secondary battery maintains an overvoltage of 0.3 V or less after being charged to 6 V.
